(19) United States
(12) Patent Application Publication
(10) Pub. No.: US 2024/0003144 A1
(43) Pub. Date: Jan. 4, 2024

(54) Reusable Trim System

(71) Applicant: Terry Anderson, Junction City, KS (US)

(72) Inventor: Terry Anderson, Junction City, KS (US)

(21) Appl. No.: 18/232,194

(22) Filed: Aug. 9, 2023

Related U.S. Application Data
(63) Continuation-in-part of application No. 17/193,452, filed on Mar. 5, 2021.

(51) Int. Cl. E04F 19/04; E04F 21/00; B23D 13/00

(52) U.S. Cl. CPC E04F 19/0459; B23D 13/00; E04F 21/0069

(57) ABSTRACT

A slot bit for a carpentry system has a first cutting larger head on an end of a shaft of the slot bit to cut a circular portion of a magnifying glass shaped slot via teeth in a face and a circumference thereof and a second annularly adjacent cutting smaller head to cut a handle portion of the magnifying glass shaped slot via circumferential teeth thereof. The disclosed TR'IT Trim Reusable Installation Slot Bit and system simplifies trimming forgoing the need to tape before painting while significantly reducing water intrusion points often associated with the process. The disclosure is uniquely designed to prevent trim replacement during removal/renovations and offers an alternative version ideal for performing external trim tasks.

### CROSS REFERENCE

The present utility application is a Continuation in Part of the pending application U.S. Ser. No. 17/193,452 by Terry Anderson filed Mar. 5, 2021 and incorporated by reference in its entirety.

### BACKGROUND

Within the construction/household repair industry painting rooms and redoing stained finished trim is a common necessity. However, that task can be labor some and often requires having to replace new trim and/or spraying surfaces in prep to isolate the work actually to be renovated, all of which prolongs work time and still may lead to trim damage. There have been no products available as original equipment or as an aftermarket to address this problem.

A cleaner more efficient process to complete initial and recurring work requirements pertaining to external and internal trim work. There have been no products available as original equipment or as an aftermarket to address this problem either.

There exists a need for Reusable Trim that is not being met by any known or disclosed device or system of present. The need is economical and practical for the professional finish carpenter and the home owner and home improvement warrior.

### SUMMARY OF THE INVENTION

The slot bit for a carpentry system has a first cutting larger head on an end of a shaft of the slot bit to cut a circular portion of a magnifying glass shaped slot via teeth in a face and a circumference thereof and a second annularly adjacent cutting smaller head to cut a handle portion of the magnifying glass shaped slot via circumferential teeth thereof.

The Slot Bit and Refastening Trim System disclosed also known as the TR'IT trim reusable installation tool, introduces a novel disclosure that manages work tasks related to trim repairs. Ingenious and practical, the reusable trim system offers a modern system that allows interior and exterior trim to be installed with ease while preserving a professional finish. The reusable trim system ultimately preserves old trim from breaking during removal of nailed in preexisting trim. This tool, also, enables quick clean up post use.

The disclosure includes a magnifying glass shaped slot in a back thereof having a handle portion and a circular portion wherein the handle portion flanges out into a recess of a width and a depth equal to a width and a depth of the circular portion. The disclosure also includes an offset fastener having a head offset from and a body wherein the head is received into the circular portion and a body thereof slides through the handle portion as the head slides through the recess portion and locks therein. The disclosure further includes a backing trim configured to be adjacent the back of the carpentry trim and provide a fastening substrate for a plurality of fasteners therefrom into the carpentry trim.

### BRIEF DESCRIPTION OF THE DRAWINGS

FIG. 1A is a back perspective view of the Reusable Trim System and component parts including a pointed auto trim fastener in accordance with an embodiment of the present disclosure.

FIG. 1B is a back perspective view of the Reusable Trim System and component parts including a flat tipped auto trim fastener in accordance with an embodiment of the present disclosure.

FIG. 2 is a perspective view of a baseboard backing and lag screw for the reusable trim system in accordance with an embodiment of the present disclosure.

FIG. 3 is a back perspective view of the lag screw inserted into the magnifying glass shape slot in accordance with an embodiment of the present disclosure.

FIG. 4 is a back perspective view of the magnifying glass shape slot and offset bolt inserted therein in accordance with an embodiment of the present disclosure.

FIG. 5 is a front perspective of a baseboard backing and a fastener plate thereon in accordance with an embodiment of the present disclosure.

FIG. 6 is a front perspective of a baseboard backing and a baseboard adjacent thereto in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

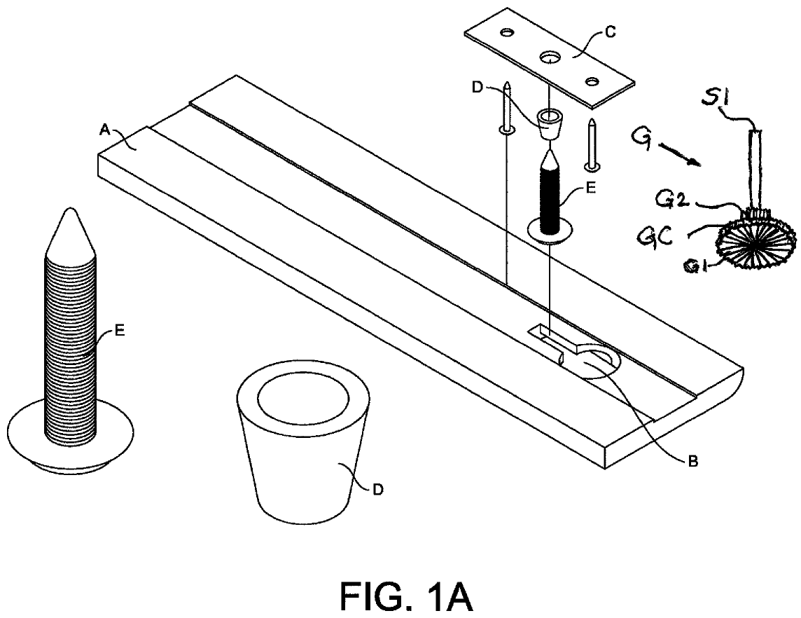

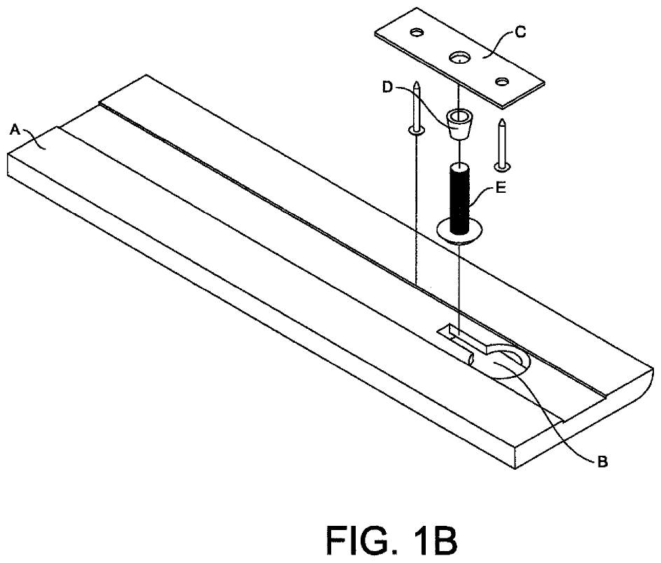

FIG. 1A is a back perspective view of the Reusable Trim System and component parts including a sharp tipped auto trim fastener in accordance with an embodiment of the present disclosure. The view shows the slot bit G including the cutting face G1 with radial teeth in a first cutting larger head, and the cutting circumference GC with cutting teeth parallel with a slot bit shaft S1, and the second cutting smaller head G2. Also depicted are the following six(6) items: parts developed as a primary metal plate with holes C, a back slot B, grommet D with a taper pointing toward the back slot B, an offset fastener also known as an automobile trim fastener E, or simply auto trim fastener herein for snap fastening automobile trim onto cars through plastic ribs which catch on a metal hole edge and are withdrawable therefrom but resist withdrawal and have a head and repurposed sharp tipped for house trim installation, a baseboard A with complementary backing F, in accordance with an embodiment of the present disclosure. A user can place the auto trim fastener E, also known as an offset fastener herein, with a metal point into the slot of the trim and transfer the exact location on a wall to the location for the metal plate C.

FIG. 1B is a back perspective view of the Reusable Trim System and component parts including a flat tipped auto trim fastener in accordance with an embodiment of the present disclosure. The auto trim fastener E, also known as ‘the fastener’ or the ‘offset fastener’ herein is flat tipped for specific applications.

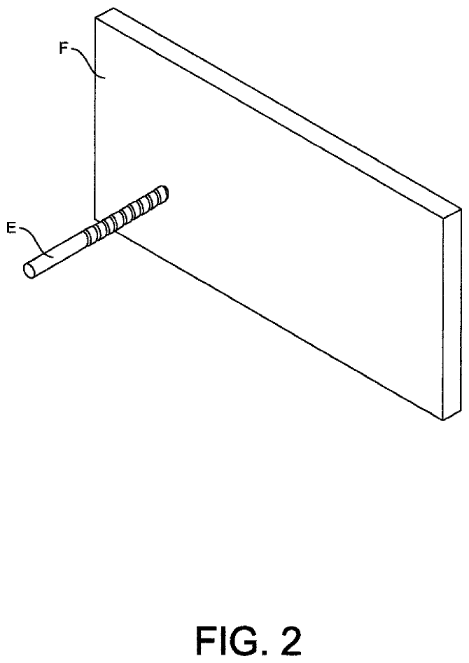

FIG. 2 is a perspective view of the baseboard backing and lag screw for the reusable trim system including E offset fastener or auto trim fastener and F backing in accordance with an embodiment of the present disclosure.

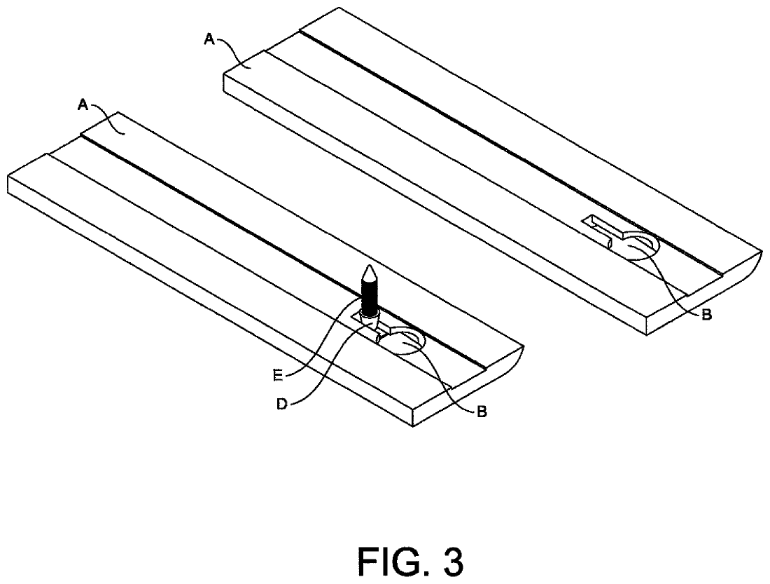

FIG. 3. Is a back perspective view of the lag screw inserted into the magnifying glass shape slot showing: A. Baseboard, B. Back slot, D. grommet with a taper pointing towards the back slot D, and E. auto trim fastener in accordance with an embodiment of the present disclosure.

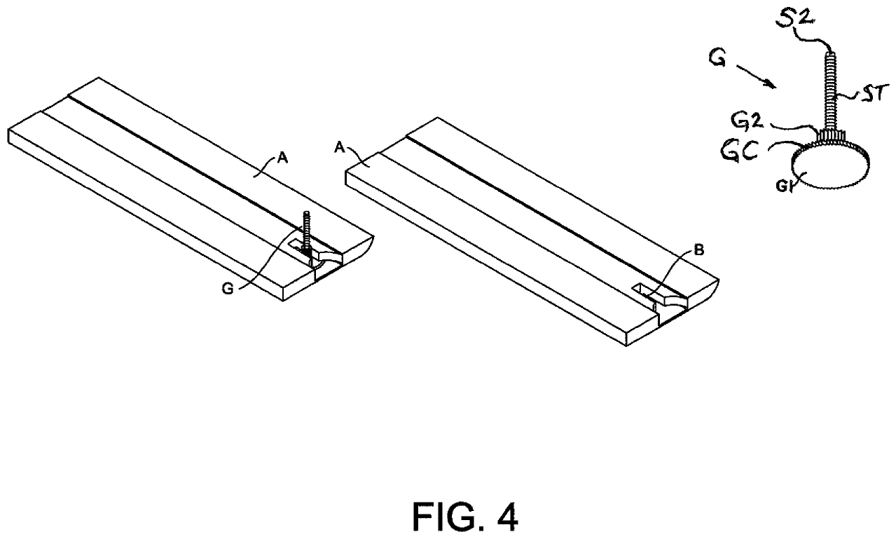

FIG. 4. Is a back perspective view of the magnifying shape slot and offset bolt inserted therein showing: A. Baseboard, B. Back slot, and G slot bit with a first cutting head on an end of a shaft of the slot bit to cut the circular portion of the slot and a second annularly adjacent cutting smaller head to cut the handle portion of the slot in accordance with an embodiment of the present disclosure. The face G1 does not include radial teeth in the first cutting larger head because the slot bit cuts from an edge of the baseboard carpentry trim A. The cutting circumference GC with cutting teeth parallel with a slot bit shaft S2, and the second cutting smaller head G2 are shown. The slot bit shaft S2 includes a helical thread ST for applications where the slot bit is left in the magnifying shaped slot for use as a fastener depicted in the second instance of the baseboard carpentry trim depicted.

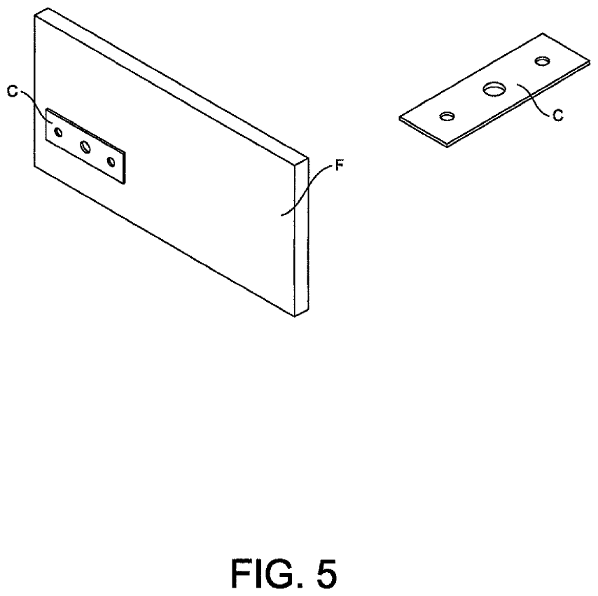

FIG. 5. Is a front perspective view of a baseboard backing and a fastener plate thereon showing: C. Metal plate with holes, F. backing in accordance with an embodiment of the present disclosure.

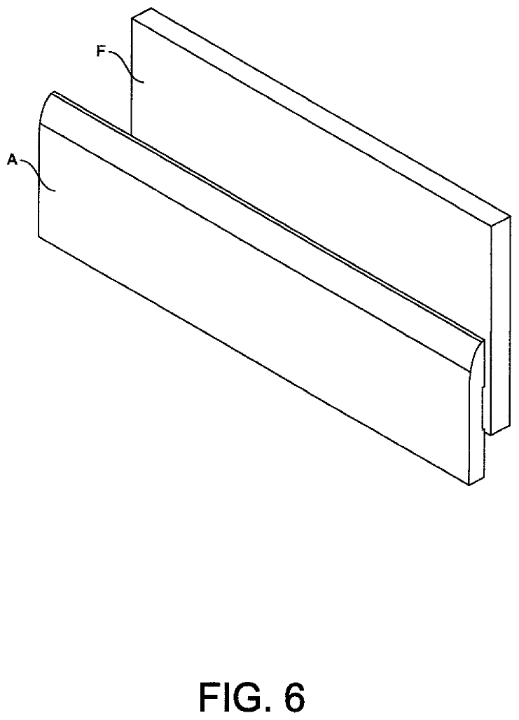

FIG. 6. Is a front perspective view of a baseboard backing and a baseboard adjacent thereto showing: A. Baseboard, and F. backing in accordance with an embodiment of the present disclosure.

The disclosed TR'IT Trim Reusable Tool allows most interior and exterior trim to be installed and removed without the need for nails. Thus eliminating the requirement to purchase new trim, minimizing or eliminating taping trim to paint, and allowing trim to be removed placed in a convenient location to repaint or refurbish without splashing or splattering on existing floors, walls, and ceilings. It reduces cost and is environmentally friendly by preserving the old trim from breaking during the removal process of trim that is nailed in. By using the slot bit of the TR'IT Trim Reusable Tool and system allows for quick painting by eliminating hours of work taping and the tedious work with a professional finish. The tool works with Dremel® or similar like drivers with a guard to keep a straight surface while drilling and cutting slots. A fastener with a point is used to identify the exact location on a wall or on a backing to place the plate and fastener while the entire removal process simply requires a with an interference to identify the exact location to place the fastener while the entire removal process simply requires a utility knife to cut before trim removal.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A bit for a carpentry system and comprising:
a slot bit with a first cutting larger head on an end of a shaft of the slot bit to cut a circular portion of a magnifying glass shaped slot via teeth in a face and a circumference thereof and a second annularly adjacent cutting smaller head to cut a handle portion of the magnifying glass shaped slot via circumferential teeth thereof; and
a carpentry trim defining the magnifying glass shaped slot in a back face of the carpentry trim from a use of the slot bit and having the handle portion adjacent the back and the circular portion adjacent the handle portion and comprising a recess of a width and a depth.

2. The bit for the carpentry system of claim 1, further comprising an offset fastener having a head offset from a body having plastic ribs and a tip thereof wherein the head is received into the circular portion and the body thereof slides through the handle portion as the head slides through the recess and rests therein.

3. The bit for the carpentry system of claim 1, further comprising a grommet with a taper pointing towards the magnifying glass shaped slot and extending from the recess and around the offset fastener and adjacent the magnifying glass shaped slot to provide a frictional spacer there between.

4. The bit for the carpentry system of claim 1, wherein the magnifying glass shaped slot is placed adjacent each end of the carpentry trim and one in a mid-portion there between.

5. The bit for the carpentry system of claim 1, wherein the offset fastener plastic ribs catch on a hole edge of the grommet and resist withdrawal therefrom via the plastic ribs.

6. The bit for the carpentry system of claim 1, wherein the carpentry trim is a baseboard molding and a door casing.

7. The bit for the carpentry system of claim 1, wherein the teeth in a face of the cutting larger head are radial cutting teeth.

8. A bit for a carpentry fastening system and comprising:
a slot bit with a first cutting larger head on an end of a shaft of the slot bit to cut a circular portion of a magnifying glass shaped slot via teeth in a circumference thereof and a second annularly adjacent cutting smaller head to cut a handle portion of the magnifying shaped slot via circumferential teeth thereof;
a carpentry trim defining a magnifying glass shaped slot in an edge of the carpentry trim having the handle portion and the circular portion via a use of the slot bit wherein the handle portion flanges out into a recess of a width and a depth equal to a width and a depth of the circular portion;
an offset fastener having a head offset from and a body and a tip thereof wherein the head is received into the circular portion and a body thereof slides through the handle portion as the head slides through the recess portion and rests therein;
a metal plate configured to receive and catch the offset fastener tip plastic ribs against an edge of a hole therein and to itself fasten onto a wall; and
a grommet with a taper pointing towards the magnifying glass shaped slot and extending from the recess and around the offset fastener and adjacent the magnifying glass shaped slot and the metal plate to provide a frictional fit there between.

9. The bit for the carpentry fastening system of claim 8, wherein the grommet on the body of the offset fastener is configured to provide a high durometer spacer between the back of the carpentry trim and the head of the offset fastener.

10. The bit for the carpentry fastening system of claim 8, wherein the offset fastener comprises a double head wherein a first head is received into the recess and a second head provides the offset.

11. A bit for a carpentry refastening system and comprising:
a slot bit with a first cutting larger head on an end of a shaft of the slot bit to cut a circular portion of a magnifying glass shaped slot via radial teeth on a face and on a circumference thereof and a second annularly adjacent cutting smaller head to cut the handle portion of the slot via circumferential teeth therein;
a carpentry trim defining the magnifying glass shaped slot in a back of the carpentry trim having a handle portion adjacent the back and a circular portion and comprising a recess of a width and a depth via a use of the slot bit in a drill;
an offset fastener having a head offset from and a body comprising plastic ribs and a tip thereof wherein the head is received into the circular portion and a body thereof slides through the handle portion as the head slides through the recess therein;
a backing trim configured to be adjacent the back of the carpentry trim and provide a refastening substrate for a plurality of fasteners therefrom into the carpentry trim after a removal of the carpentry trim from a wall; and
a grommet with a taper pointing towards the magnifying glass shaped slot and extending from the recess around the offset fastener and adjacent the magnifying glass shaped slot and the backing trim to provide a frictional spacer fit there between.

12. The bit for the carpentry refastening system of claim 11, further comprising a metal plate configured to receive the offset fastener and to itself fasten onto the backing trim.

13. The bit for the carpentry refastening system of claim 11, further comprising a semi-circular portion disposed at an edge of the carpentry trim.

14. The bit for the carpentry refastening system of claim 11, further comprising a knurl in a perimeter of the head of the offset fastener and configured to lock the head into the recess.

15. The bit for the carpentry refastening system of claim 11, wherein the offset fastener plastic ribs catch on a hole edge of the grommet and resist withdrawal therefrom via the plastic ribs.

16. The bit for the carpentry refastening system of claim 11, wherein the handle portion is directed toward a lateral side of the carpentry trim in a door casing application.

17. The bit for the carpentry refastening system of claim 11, wherein the handle portion is directed toward an end of the trim and parallel to a lateral side of the trim for a crown molding application.

18. The bit for the carpentry refastening system of claim 11, wherein a height dimension of the carpentry trim matches a height dimension of the backing trim.

19. The bit for the carpentry refastening system of claim 11, further comprising a metal plate configured to receive the offset fastener body into a threaded opening therein and to itself fasten onto the backing trim.

20. The bit for the carpentry refastening system of claim 19, wherein the metal plate is configured with a hole there through to receive and to catch the offset fastener tip plastic ribs against an edge of the hole.
